(19) United States
(12) Patent Application Publication
(10) Pub. No.: US 2023/0268522 A1
(43) Pub. Date: Aug. 24, 2023

(54) BIPOLAR PLATE WITH SEALING ARRANGEMENT, FUEL CELL WITH BIPOLAR PLATE, AND METHOD FOR SEALINGLY COVERING

(71) Applicant: Robert Bosch GmbH, Stuttgart (DE)

(72) Inventors: Jan Hendrik Ohs, Renningen (DE); Stefan Schoenbauer, Ditzingen (DE)

(21) Appl. No.: 18/007,737

(22) PCT Filed: Apr. 27, 2021
(86) PCT No.: PCT/EP2021/060911

§ 371 Date: Dec. 1, 2022

(30) Foreign Application Priority Data
Jun. 4, 2020 (DE) 10 2020 207 010.5

(51) Int. Cl. H01M 8/0276; H01M 8/0258; H01M 8/0286

(52) U.S. Cl. CPC H01M 8/0276; H01M 8/0258; H01M 8/0286

(57) ABSTRACT

The invention relates to a bipolar plate (30) for a fuel cell (10). The bipolar plate (30) has a first bipolar plate half (32) and a second bipolar plate half (34), and the bipolar plate (30) has at least one fluid channel (36) for carrying at least one fluid (F). The first bipolar plate half (32) has at least one bonded connection (40) to the second bipolar plate half (34), and the bipolar plate (30) comprises at least one sealing arrangement (50) which sealingly covers the at least one bonded connection (40). The invention also relates to a fuel cell and a method for sealingly covering a bonded connection of the first bipolar plate half (32) to the second bipolar plate half (34) of the bipolar plate (30).

### BACKGROUND OF THE INVENTION

Fuel cells are electrochemical energy converters in which hydrogen and oxygen are converted into water, electrical energy and heat. The reaction gases hydrogen and oxygen as well as a cooling liquid are fed through a channel structure of the fuel cell into an active reaction region of the fuel cell. The gases diffuse through gas diffusion layers into the catalyst layer in which the electrochemical reactions of the fuel cell take place. The bipolar plates of a fuel cell usually consist of two embossed metal sheets. The channel structures in the metal sheets of the bipolar plates respectively form compartments for the three media hydrogen, air and coolant. The coolant usually flows between the two metal sheets of the bipolar plates. In order to seal the coolant channels from the surroundings, plastic seals such as elastomer or thermoset seals, or sealing by means of weld seams, for example with laser welding, are usually selected in the prior art. Bipolar plates usually have a coating to minimize the contact resistance and for corrosion protection. The coating of the bipolar plates is generally applied before the two plate halves are welded to one another. This sequence is due on the one hand to the fact that so-called pre-coating, in which the coating is already applied before the embossing onto the raw material of the bipolar plates, for example in the form of a steel roll, is usually less expensive in comparison with post-coating of the already embossed bipolar plate. On the other hand, welding beforehand and subsequent coating of the bipolar plates would mean that the two contiguous internal faces of the two bipolar plate metal sheets can no longer be coated since access is prevented because of the welding. Welding of the bipolar plate metal sheets involves heat and/or thermal input. The already applied coating and therefore the corrosion protection may thereby disadvantageously be locally destroyed.

### SUMMARY OF THE INVENTION

The present invention discloses a bipolar plate for a fuel cell, wherein the bipolar plate has at least one sealing device. The present invention furthermore discloses a fuel cell having at least one membrane-electrode unit, at least one gas diffusion layer and at least one bipolar plate. The present invention furthermore discloses a method for the leaktight covering of a materially bonded connection of the first bipolar plate half to the second bipolar plate half of the bipolar plate. Further features and details of the invention may be found in the claims, the description and the drawings. In this case, features which are described in connection with the bipolar plate according to the invention naturally also apply in connection with the fuel cell according to the invention and the method according to the invention, and respectively vice versa, so that mutual reference is or may always be made in respect of the disclosure to the individual aspects of the invention.

According to a first aspect, the present invention provides a bipolar plate for a fuel cell, wherein the bipolar plate has a first bipolar plate half and a second bipolar plate half, wherein the bipolar plate has at least one fluid channel for conveying at least one fluid and wherein the first bipolar plate half has at least one materially bonded connection to the second bipolar plate half, wherein the bipolar plate comprises at least one sealing device and the at least one sealing device covers the at least one materially bonded connection in a leaktight fashion. The bipolar plate for a fuel cell is preferably configured for use in a motor vehicle and/or for the propulsion of the motor vehicle. A materially bonded connection may, in the scope of the invention, for example be a weld point, a weld seam and/or another materially bonded and/or monolithic connection of the first bipolar plate half and the second bipolar plate half. The materially bonded connection in the bipolar plate according to the invention, or in the fuel cell, is at least partially exposed to and/or in contact with a corrosion-susceptible, otherwise chemically aggressive and/or material-disintegrating environment. The bipolar plate according to the invention has a coating, in particular against corrosion, at least in sections. The creation of the materially bonded connection, in particular the welded connection, creates local destruction of the coating of the two bipolar plate halves. The no longer coated locations have a corrosion risk. Furthermore, damage in the coating makes it possible for the coating to be undermined at the fault. In this case, there is a risk that even sizeable coating regions adjacent to the weld seam and/or the weld point may break away. Not only the relatively small area of a weld seam and/or a weld point, but also the adjacent zones, are therefore in danger of corrosion. Through leaktight covering of the materially bonded connection by the at least one sealing device according to the invention, this is prevented or at least advantageously influenced. According to the invention, leaktight covering of the materially bonded connection by the at least one sealing device is leaktight covering respectively of the rear-side locations of the materially bonded connection on the first bipolar plate half and/or on the second bipolar plate half. A front side and a rear side of the bipolar plate halves are in this case defined in such a way that the front sides of the bipolar plates are arranged in contact with one another for the materially bonded connection and the rear sides of the bipolar plate halves respectively represent the opposite side and/or surface of the bipolar plate halves.

The sealing device may preferably be clamped to the bipolar plate and/or arranged and fastened by means of the surface pressure of the entire fuel cell. The at least one sealing device may be configured as an elastomer seal and/or be made from other polymers or polymer composites, for example rubber, EPDM, silicone, FKM. Preferably, the at least one sealing device is arranged at least in sections, preferably fully, in a fluid channel of the bipolar plate for hydrogen and/or oxygen. A bipolar plate according to the invention configured in this way is particularly advantageous since the at least one materially bonded connection is covered in a leaktight fashion by the at least one sealing device and protection of the connection locations, particularly the rear sides of the connection locations, of the bipolar plate halves against corrosion influences and/or environmental influences is therefore made possible with economical and simple means.

According to one preferred embodiment of the bipolar plate according to the invention, the at least one sealing device comprises at least two sealing halves, one of the at least two sealing halves in particular respectively being arranged on one of at least two sides of the bipolar plate. The at least two sealing halves may be formed together, materially bonded or separately. Preferably, the two sealing halves are arranged on opposite sides, in particular on the rear sides of the materially bonded connection, of the two bipolar plates. A bipolar plate configured in this way allows advantageous leaktight covering of the materially bonded connection, in particular the weld seam, on both sides. The entire region or substantially the entire region of the coating damaged by the materially bonded connection is therefore preferably covered in a leaktight fashion by the at least one sealing device, and therefore advantageously protected against corrosion. Particularly advantageously, one sealing half is respectively arranged on one bipolar plate half. The term “X or substantially X” is intended in the scope of the invention to be understood as possible minor deviation, for example due to manufacturing tolerances and/or material properties, without affecting the underlying intended function of the feature.

According to one preferred embodiment of the bipolar plate according to the invention, the at least one sealing device is additively applied onto the bipolar plate and/or is adhesively bonded to the bipolar plate. Additive application and/or adhesive bonding of the at least one sealing device to the bipolar plate is a particularly advantageous configuration since leaktight covering according to the invention is made possible with simple means and economically. Additive application and/or adhesive bonding represents installation space-optimized fastening of the sealing device on the bipolar plate. The bipolar plate may be pretreated for improved holding of the sealing device on the bipolar plate. As an alternative or in addition, the sealing device may also be arranged and fastened on the bipolar plate with fastening means. The bipolar plate may likewise have means for aligning the sealing device on the bipolar plate.

According to one preferred embodiment of the bipolar plate according to the invention, the at least one sealing device covers the at least one materially bonded connection in a leaktight fashion on two sides, in particular on opposite sides, of the bipolar plate. Preferably, the sealing device may engage around laterally in an edge region of the bipolar plate and merely one sealing device may therefore cover the materially bonded connection in a leaktight fashion on two sides, in particular on opposite sides, of the bipolar plate. A sealing device configured in this way may, for example, be formed by overmolding or as a U-profiled section and be arranged fitted laterally on the bipolar plate. Besides the leaktight covering of the materially bonded connection of the first bipolar plate half to the second bipolar plate half, this preferred embodiment of the sealing device allows for example clamping of the sealing device on the bipolar plate and/or furthermore lateral dampening, sealing and/or alignment of the bipolar plate.

According to one preferred embodiment of the bipolar plate according to the invention, the at least one sealing device has a height and the first bipolar plate half and the second bipolar plate half respectively have a height, the height of the at least one sealing device corresponding to the height of the first bipolar plate half and/or of the second bipolar plate half. The height of the at least one sealing device may in this case comprise the height in the compressed state and/or the height in the uncompressed state due to the surface pressure of the fuel cell. In addition, it is possible and conceivable for the height of the at least one sealing device to compensate for a difference in thickness of the membrane-electrode unit and/or at least one gas diffusion layer in relation to an edge reinforcement in the region of the membrane-electrode unit, at and/or on which the at least one sealing device is arranged. As described above, the at least one sealing device is arranged in a fluid channel of the bipolar plate for hydrogen and/or oxygen. The height of the fluid channels in the bipolar plates in this case usually corresponds to the height of the first bipolar plate half and/or of the second bipolar plate half. The design configuration of the sealing device may be formed over the entire height or substantially the entire height of the channel. Materially bonded connections are however also conceivable and possible at positions of the bipolar plate at which no sealing device is provided over the entire height or substantially the entire height of the first bipolar plate half and/or of the second bipolar plate half, because the sealing device is for example negative for a flow behavior of a fluid at said location. As an alternative or in addition to forming the at least one sealing device over the entire height or substantially over the entire height of the channel, the at least one sealing device may merely cover the materially bonded connection in a leaktight fashion as a thin coating. Particularly in the region of the feed and discharge devices of a fuel cell, which are usually configured as ports, a sealing device configured in this way may advantageously allow and/or improve a fluid flow. For example, a weld seam is arranged around a hydrogen port in order to avoid feeding hydrogen into the coolant channel structure. The feed into the hydrogen channel structure of the fuel cell and/or of the bipolar plate is, however, configured in a fluid-communicating fashion and should advantageously not be closed and/or partially blocked by a sealing device, so that hydrogen can flow unimpeded into the hydrogen channel structure. In order to prevent or at least advantageously influence corrosion at the weld seam and at these locations as well, a sealing device according to the invention is applied as a thin plastic coating in this port region. The plastic coating is therefore much thinner and/or has a smaller height than the first bipolar plate half and/or the second bipolar plate half. For example, hydrogen may therefore flow through the thin sealing device into the fuel cell although the corrosion protection effect is nevertheless still ensured.

According to one preferred embodiment of the bipolar plate according to the invention, the at least one sealing device is arranged in the at least one fluid channel and/or a sealing groove, particularly in and/or on the first bipolar plate half and/or the second bipolar plate half. According to this embodiment of the bipolar plate according to the invention, it is particularly advantageous for the at least one sealing device to be arranged, in particular preferably fully, in a fluid channel of the bipolar plate for hydrogen and/or oxygen. A bipolar plate according to the invention configured in this way is particularly advantageous since the at least one materially bonded connection is covered in a leaktight fashion by the at least one sealing device in the at least one fluid channel and protection of the connection locations, particularly the rear sides of the connection locations, of the bipolar plate halves against corrosion influences and/or environmental influences is therefore made possible with economical and simple means. As an alternative or in addition, the sealing device is arranged between the first bipolar plate half and the second bipolar plate half.

According to one preferred embodiment of the bipolar plate according to the invention, the at least one sealing device has a width and the at least one materially bonded connection has a width, the width of the sealing device corresponding to at least 500% of the width of the materially bonded connection, the sealing device being configured in particular with a width of from 3 to 5 mm. Furthermore, it is particularly preferred for the width of the sealing device to be greater by at least a factor of 10, 20, 30 or 50 than the width of the materially bonded connection. The width of the materially bonded connection is to be understood in the scope of the invention for example as the width of a weld seam for the materially bonded connection of the first and second bipolar plate halves. As described above, damage in the coating of the bipolar plate halves makes it possible for the coating to be undermined at the fault. In this case, there is a risk that even sizeable coating regions adjacent to the weld seam and/or the weld point may break away. Not only the relatively small area of a weld seam and/or a weld point, but also the adjacent zones, are therefore in danger of corrosion. Through leaktight covering of the materially bonded connection by the at least one sealing device according to the invention, over a width of 110, 125, 150, 200, 250 or 300% of the width of the materially bonded connection, this is prevented or at least advantageously influenced.

According to a second aspect, the present invention provides a fuel cell having at least one membrane-electrode unit, at least one gas diffusion layer and at least one bipolar plate according to the first aspect, wherein the sealing device of the bipolar plate is arranged between the at least one membrane-electrode unit, the gas diffusion layer and/or an edge reinforcement and the at least one bipolar plate. With the described fuel cell, all the advantages which have already been described for the bipolar plate according to the first aspect of the invention are obtained. A fuel cell according to the invention configured in this way is particularly advantageous since the at least one materially bonded connection is covered in a leaktight fashion by the at least one sealing device of the bipolar plate and protection of the connection locations, particularly the rear sides of the connection locations, of the bipolar plate halves against corrosion influences and/or environmental influences is therefore made possible with economical and simple means.

According to one preferred embodiment of the fuel cell according to the invention, the sealing device is connected in a fluid-tight fashion to the at least one membrane-electrode unit and/or to the at least one bipolar plate. A fuel cell configured in this way is particularly advantageous since leaktight covering according to the invention of the materially bonded connection and furthermore fluid sealing between the sealing device and the at least one membrane-electrode unit and/or the at least one bipolar plate is made possible with simple means and economically.

According to a third aspect, the present invention provides a method for the leaktight covering of a materially bonded connection of the first bipolar plate half to the second bipolar plate half of the bipolar plate according to the first aspect for the fuel cell according to the second aspect, having the following steps:
arrangement of the first bipolar plate half on the second bipolar plate half,
materially bonded connection of the first bipolar plate half to the second bipolar plate half,
leaktight covering of the materially bonded connection with at least one sealing device.

With the described method, all the advantages which have already been described for the bipolar plate according to the first aspect of the invention and the fuel cell according to the second aspect of the invention are obtained. The first bipolar plate half and the second bipolar plate half are preferably arranged with their front sides in contact with one another. Usually, the materially bonded connection between the bipolar plate halves is made possible by thermal input through the rear sides of the bipolar plate halves. Particularly on said rear sides, the relevant damage to the coating of the bipolar plate halves, or to the rear sides of the bipolar plate halves, is consequently at particular risk because of the contact with corrosive fluids. Conversely, the front sides of the bipolar plates are usually arranged directly in contact with one another. The locations of the damage of the coating are susceptible, for example, to corrosion during operation of the fuel cell and/or of the bipolar plate. The sealing devices according to the invention are arranged sealing and covering, particularly on the rear sides of the bipolar plate halves, at the materially bonded connection for corrosion protection of said locations, and they therefore advantageously allow corrosion protection of the bipolar plate halves and/or of the materially bonded connection.

### BRIEF DESCRIPTION OF THE DRAWINGS

A bipolar plate according to the invention, a fuel cell and a method will be explained in more detail below with the aid of the drawings in which, respectively schematically:

FIG. 1 shows a side view of a fuel cell having a plurality of bipolar plates and a multiplicity of sealing devices at the materially bonded connections of the bipolar plate halves,

FIG. 2 shows a side view of a further fuel cell having a plurality of bipolar plates and a multiplicity of sealing devices at the materially bonded connections of the bipolar plate halves, and

FIG. 3 shows a flowchart of a method according to the invention.

### DETAILED DESCRIPTION

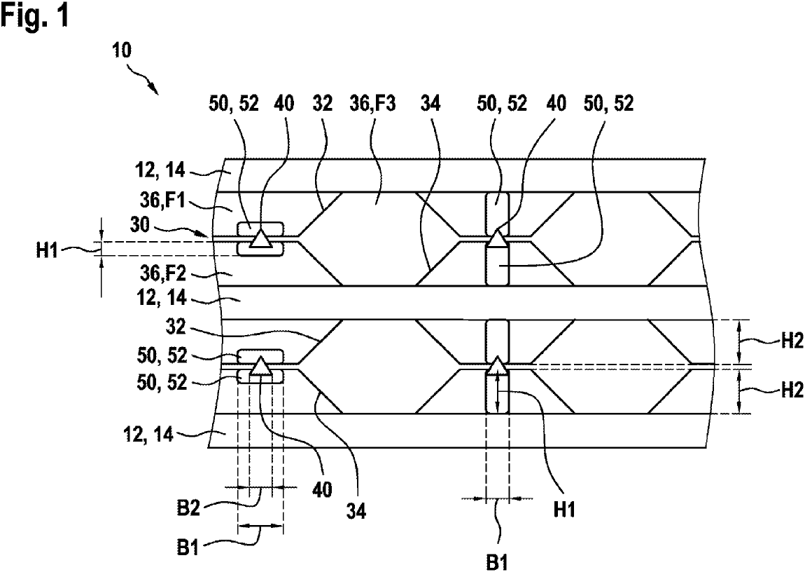

Elements with the same function and functionality are respectively provided with the same references in FIGS. 1 to 3.

FIG. 1 shows a side view of a fuel cell 10 having a plurality of bipolar plates 30 and a multiplicity of sealing devices 50 at the materially bonded connections 40 of the bipolar plate halves 32, 34. The fuel cell 10 is constructed in a stacked fashion with alternating bipolar plates 30 and membrane-electrode units 12. The membrane-electrode unit 12 may comprise the gas diffusion layers 14 and/or the gas diffusion layers 14 may directly adjoin the membrane-electrode unit 12. The bipolar plates 30 are formed from a first bipolar plate half 32 and a second bipolar plate half 34. The bipolar plate halves 32, 34 are arranged in contact with one another on a front side and are connected to one another by means of materially bonded connections 40. At the connection locations, in particular on the connection locations on the rear side of the bipolar plate halves 32, 34, the coating of the bipolar plate halves 32, 34 is damaged by the thermal input of the materially bonded connection 40 and the material of the bipolar plate halves 32, 34 is therefore at risk of corrosion. Configured in this way, the bipolar plate 30 forms fluid channel structures for example for three fluids F1, F2, F3 of a fuel cell 10. For example, a channel structure for a cooling liquid F3 to flow through is formed between two materially bonded connections 40. Adjacent respectively above and below at the materially bonded connections 40, channel structures are formed for hydrogen F1 and oxygen F2. The channel structures for hydrogen F1 and oxygen F2 are configured so as to transmit fluid to the membrane-electrode units 12 and/or gas diffusion layers 14. In order to protect the materially bonded connections 40 against environmental influences in the fuel cell 10, and in particular against corrosion, at least one sealing device 50 is respectively arranged on and/or at the materially bonded connections 40. In FIG. 1, a sealing half 52 of a sealing device 50 is respectively arranged above and below at the materially bonded connections 40. In the left channel structure, the sealing device 50 is configured with a height H1 which is substantially less than the height H2 of the channel structure and of the first bipolar plate half 32 or of the second bipolar plate half 34. The sealing devices 50 according to the invention are therefore arranged sealing and covering, particularly on the rear sides of the bipolar plate halves 32, 34, at the materially bonded connection 40 for corrosion protection of said locations of the materially bonded connections 40, and they therefore advantageously allow corrosion protection of the bipolar plate halves 32, 34 and/or of the materially bonded connection 40. At the same time, however, flow around the sealing devices 50 still remains possible because of the small height H1 of the sealing devices 50. In the central region of the fuel cell 10 shown in FIG. 1, the sealing device 50 is configured with a height H1 which corresponds or substantially corresponds to the height H2 of the channel structure and of the first bipolar plate half 32 and/or of the second bipolar plate half 34. The sealing devices 50 may be adhesively bonded, clamped and/or otherwise fastened to the respective bipolar plates 30 and/or the fuel cell 10. As described above, damage in the coating of the bipolar plate halves 32, 34 makes it possible for the coating to be undermined at the fault. In this case, there is a risk that even sizeable coating regions adjacent to the weld seam 40 and/or the weld point 40 may break away. Not only the relatively small area of a weld seam 40 and/or a weld point 40, but also the adjacent zone, are therefore in danger of corrosion. Through leaktight covering of the materially bonded connection 40 by the at least one sealing device 50 according to the invention, over a width B1 of 110, 125, 150, 200, 250 or 300% of the width B2 of the materially bonded connection 40, this is prevented or at least advantageously influenced. A bipolar plate 30 according to the invention configured in this way and the fuel cell 10 according to the invention are particularly advantageous since the at least one materially bonded connection 40 is covered in a leaktight fashion by the at least one sealing device 50 and protection of the connection locations, particularly the rear sides of the connection locations, of the bipolar plate halves 32, 34 against corrosion influences and/or environmental influences is therefore made possible with economical and simple means.

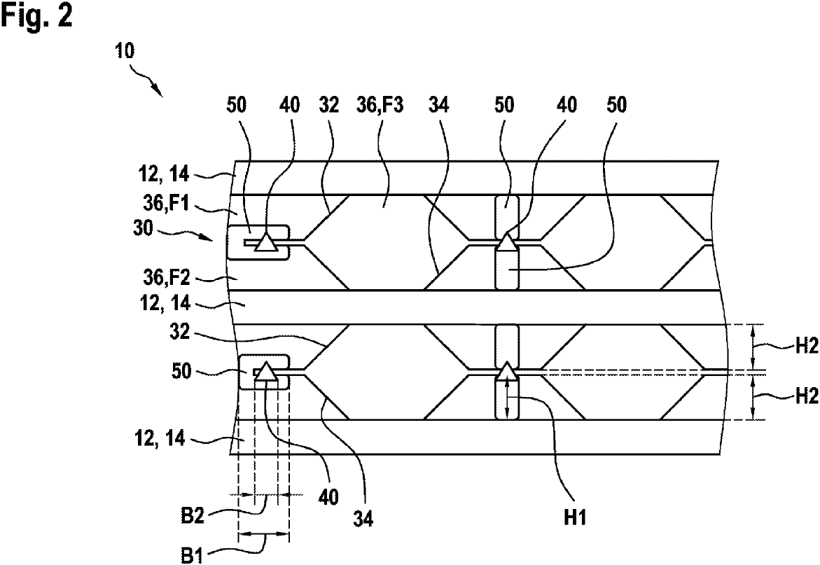

FIG. 2 shows a side view of a further fuel cell 10 having a plurality of bipolar plates 30 and a multiplicity of sealing devices 50 at the materially bonded connections 40 of the bipolar plate halves 32, 34. Further to the comments relating to the fuel cell 10 in FIG. 1, the fuel cell 10 in FIG. 2 shows that the sealing devices 50 shown on the left cover the respective materially bonded connections 40 in a leaktight fashion on two sides, in particular on opposite sides, of the bipolar plate 30. The left sealing devices 50 engage laterally around the bipolar plates 30 in an edge region of the bipolar plates 30. Merely one materially bonded sealing device 50 therefore makes it possible to cover the materially bonded connection 40 in a leaktight fashion on two sides, in particular on opposite sides, of the bipolar plate 30. A sealing device 50 configured in this way is formed, for example, as a U-profiled section and is arranged fitted laterally on the bipolar plate 30. Besides the leaktight covering of the materially bonded connection 40 of the first bipolar plate half 32 to the second bipolar plate half 34, this preferred embodiment of the sealing device 50 allows for example clamping of the sealing device 50 on the bipolar plate 30 and/or furthermore lateral dampening, sealing and/or alignment of the bipolar plate 30.

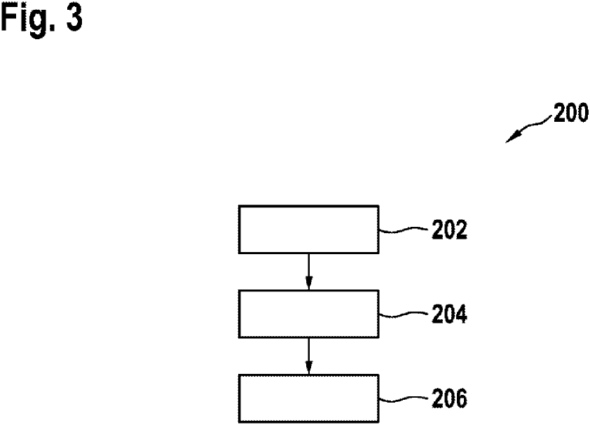

FIG. 3 shows a flowchart of a method 200 according to the invention for the leaktight covering of a materially bonded connection 40 of the first bipolar plate half 32 to the second bipolar plate half 34 of the bipolar plate 30 according to the first aspect for the fuel cell 10 according to the second aspect. In a first method step 202, the first bipolar plate half is arranged on the second bipolar plate half. In a second method step 204, the first bipolar plate half is connected in a materially bonded fashion to the second bipolar plate half and the materially bonded connection 40 is therefore produced. In a third method step 206, the materially bonded connection 40 is covered in a leaktight fashion with at least one sealing device 50.

1. A bipolar plate (30) for a fuel cell (10), wherein the bipolar plate (30) comprises
a first bipolar plate half (32),
a second bipolar plate half (34),
at least one fluid channel (36) for conveying at least one fluid (F),
wherein the first bipolar plate half (32) has at least one materially bonded connection (40) to the second bipolar plate half (34), and
wherein the bipolar plate (30) comprises at least one sealing device (50) that covers the at least one materially bonded connection (40) in a leaktight fashion.

2. The bipolar plate (30) as claimed in claim 1,
characterized in that
the at least one sealing device (50) comprises at least two sealing halves (52).

3. The bipolar plate (30) as claimed in claim 1,
characterized in that
the at least one sealing device (50) is additively applied onto the bipolar plate (30).

4. The bipolar plate (30) as claimed in claim 1,
characterized in that
the at least one sealing device (50) covers the at least one materially bonded connection (40) in a leaktight fashion on two sides of the bipolar plate (30).

5. The bipolar plate (30) as claimed in claim 1,
characterized in that
the at least one sealing device (50) has a height (H1) and the first bipolar plate half (32) and the second bipolar plate half (34) respectively have a height (H2), the height (H1) of the at least one sealing device (50) corresponding to the height (H2) of the first bipolar plate half (32) and/or of the second bipolar plate half (34).

6. The bipolar plate (30) as claimed in claim 1,
characterized in that
the at least one sealing device (50) is arranged in the at least one fluid channel (36) and/or a sealing groove.

7. The bipolar plate (30) as claimed in claim 1,
characterized in that
the at least one sealing device (50) has a width (B1) and the at least one materially bonded connection (40) has a width (B2), the width (B1) of the sealing device (50) corresponding to at least 500% of the width (B2) of the materially bonded connection (40).

8. A fuel cell (10) having at least one membrane-electrode unit (12), at least one gas diffusion layer (14) and at least one bipolar plate (30) as claimed in claim 1,
characterized in that
the sealing device (50) of the bipolar plate (30) is arranged between the at least one membrane-electrode unit (12), the gas diffusion layer (14) and/or an edge reinforcement and the at least one bipolar plate (30).

9. The fuel cell (10) as claimed in claim 8,
characterized in that
the sealing device (50) is connected in a fluid-tight fashion to the at least one membrane-electrode unit (12) and/or to the at least one bipolar plate (30).

10. A method (200) for the leaktight covering of a materially bonded connection of the first bipolar plate half (32) to the second bipolar plate half (34) of the bipolar plate (30) of the fuel cell (10) as claimed in claim 8, the method having the following steps:
arrangement (202) of the first bipolar plate half (32) on the second bipolar plate half (34),
materially bonded connection (204) of the first bipolar plate half (32) to the second bipolar plate half (34),and
leaktight covering (206) of the materially bonded connection (40) with at least one sealing device (50).

11. The bipolar plate (30) as claimed in claim 1,
characterized in that
the at least one sealing device (50) comprises at least two sealing halves (52), one of the at least two sealing halves (52) respectively being arranged on one of at least two sides of the bipolar plate (30).

12. The bipolar plate (30) as claimed in claim 3,
characterized in that
the at least one sealing device (50) is adhesively bonded to the bipolar plate (30).

13. The bipolar plate (30) as claimed in claim 1,
characterized in that
the at least one sealing device (50) is adhesively bonded to the bipolar plate (30).

14. The bipolar plate (30) as claimed in claim 1,
characterized in that
the at least one sealing device (50) covers the at least one materially bonded connection (40) in a leaktight fashion on opposite sides of the bipolar plate (30).

15. The bipolar plate (30) as claimed in claim 1,
characterized in that
the at least one sealing device (50) is arranged in the at least one fluid channel (36) and/or a sealing groove in and/or on the first bipolar plate half (32) and/or the second bipolar plate half (34).

16. A method (200) for the leaktight covering of a materially bonded connection of the first bipolar plate half (32) to the second bipolar plate half (34) of the bipolar plate (30) of the fuel cell (10) as claimed in claim 9, the method having the following steps:
arrangement (202) of the first bipolar plate half (32) on the second bipolar plate half (34),
materially bonded connection (204) of the first bipolar plate half (32) to the second bipolar plate half (34), and
leaktight covering (206) of the materially bonded connection (40) with at least one sealing device (50).
